(19) United States
(12) Patent Application Publication
(10) Pub. No.: US 2005/0216598 A1
(43) Pub. Date: Sep. 29, 2005

(54) Network access system and associated methods

(75) Inventors: Mao-I Wu, Hsin-Chu County (TW); Ken-Ju Jung, HsinChu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/806,967

(22) Filed: Mar. 23, 2004

(51) Int. Cl. G06F 15/16

(52) U.S. Cl. 709/232; 709/249

(57) ABSTRACT

An enhanced network access system and associated methods are provided. In one example, a method for providing network access includes: providing a first access point for a first computing device; accessing a first router through the first access point; connecting the first computing device to a first network; providing a second access point for a second computing device; accessing a second router through the second access point; and connecting the second computing device to a second network.

### FIELD OF THE INVENTION

This invention relates generally to network access, and more particularly, to providing public network access to visitors of corporations.

### BACKGROUND

Customers and guests frequently visit corporations to conduct businesses that entail personal meetings. Further, during their visits, they may need to receive instructions or obtain files from their home offices and review their email messages. Therefore, it will be beneficial for those corporate visitors to gain access to the Internet. However, most corporate networks are constructed so that in order to access the Internet, one must first log on to a computer that is connected to the company intranet. Thus, to gain Internet access, a corporate visitor has to first scramble to borrow an office with a computer, and then obtain the help of a company employee to log on to the computer with that employee's user id and password. Further, once the visitor has gained access to the intranet, it is difficult to police his navigations. As a result, a visitor may inadvertently discover confidential company information residing on the intranet. Moreover, a hostile visitor of the company may even take advantage of the opportunity to actively search for restricted information of the company.

Therefore, it is desired to provide a system and method to allow visitors of a company to access the Internet, while denying them access to the company intranet.

Previously available methods for providing Internet access to corporate visitors include wireless solutions from vendors, which allow a visitor to access the Internet through his laptop computer or other wireless devices. For example, a virtual private network (VPN) may be employed to separate access flows between company employees and visitors. A VPN is a private network that takes advantage of the public telecommunications infrastructure, while maintaining privacy through the use of a tunneling protocol and security procedures. A VPN may be contrasted with a system of owned or leased lines that can only be used by one company, as its main purpose is to offer the company the same capabilities as that of privately leased lines, but at much lower cost by using the shared public infrastructure.

However, while VPN is less expensive than a privately leased line, its implementation is still quite costly, and requires the installation of new devices, such as a network access manager server.

Therefore, it is desired to offer a cost effective solution to provide convenient but restricted Internet/intranet access to visitors. To that end, it is also desired to provide visitors restricted network access by taking advantage of the existing telecommunications infrastructure of the host.

### BRIEF DESCRIPTION OF THE DRAWINGS

FIG. 1 illustrates a method for providing public network access to visitors and supplying intranet access to employees according to one embodiment of the present disclosure.

FIG. 2 illustrates a system that may be used to implement the method of FIG. 1 according to one embodiment of the present disclosure.

FIG. 3 illustrates a system of providing a visitor access route and an employee access route according to one embodiment of the present disclosure.

FIG. 4 illustrates login screens for visitors according to one embodiment of the present disclosure.

### DETAILED DESCRIPTION

For the purposes of promoting an understanding of the principles of the invention, references will now be made to the embodiments, or examples, illustrated in the drawings and specific languages will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present disclosure provides an improved system and method for providing Internet access to one group of entities while supplying intranet access to another group of entities.

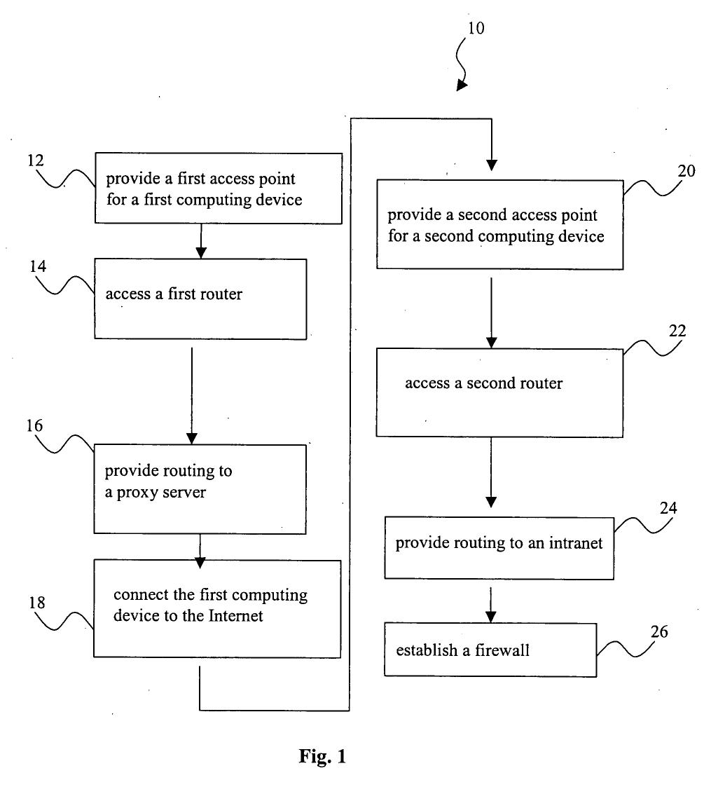

Referring now to FIG. 1, shown therein is a method 10 for providing separate network access routes to visitors and employees of a company according to one embodiment of the present disclosure. It is contemplated that besides corporations, the present disclosure may be utilized in any other suitable milieu, such as convention centers, hotels, press areas, airports or other meeting places. There, instead of separate access flows for visitors and employees, separate access routes may be provided to different groups of entities.

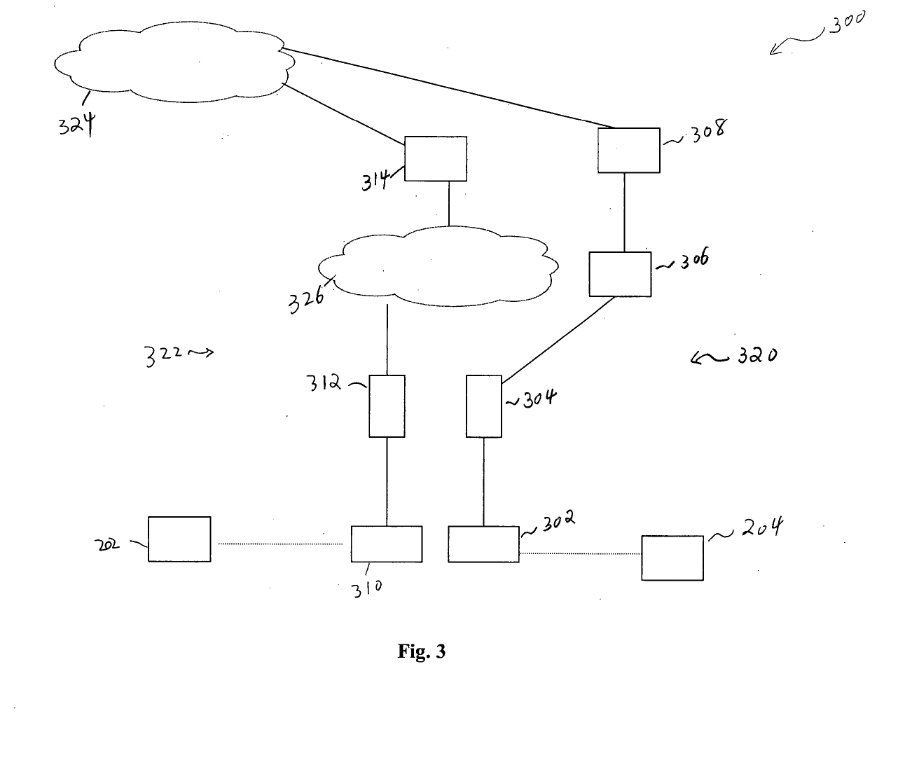

In this embodiment, the method 10 may comprise the following steps: step 12 provides a first access point for a first computing device, which may be used by a visitor of a company, step 14 accesses a first router through the first access point, step 16 provides routing to a proxy server through the first router, and step 18 connects the first computing device to the Internet, so that the visitor can access the Internet; step 20 provides a second access point for a second computing device. Step 22 accesses a second router through the second access point, which may be used by a company employee, step 24 routes to an intranet through the second router, so that the second computing device may be connected to the intranet, and step 26 provides a firewall to protect the intranet. The method 10 and associated steps 12-26 will be further described in connections with FIG. 3. It is noted that the method 10 may comprise a visitor access route, which includes steps 12-18; and an employee access route, which includes steps 20-26.

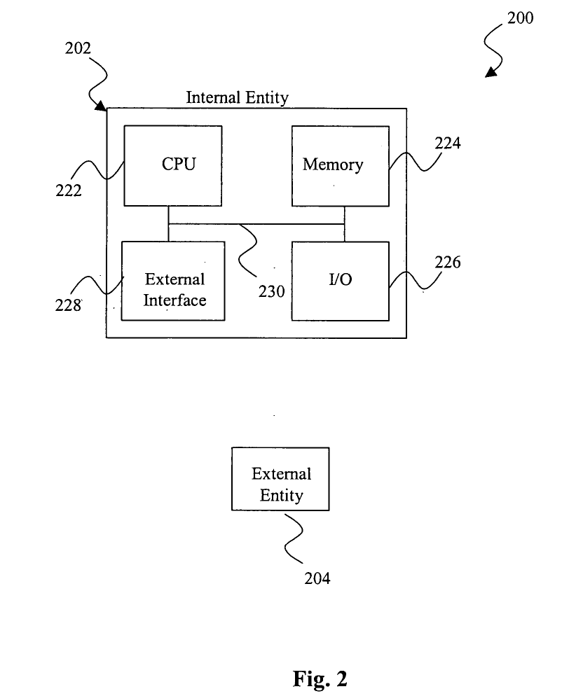

Referring now to FIG. 2, shown therein is an exemplary system 200 that may be used to implement the method 10 of FIG. 1. The system 200 includes a plurality of entities represented by one or more internal entities (e.g., employees) 202 and one or more external entities (e.g., visitors) 204 that are connected to a network (not shown). The network may be a single network or a variety of different networks, such as an intranet and the Internet, and may include both wireline and wireless communication channels.

Each of the entities 202 and 204 may include one or more computing devices such as personal computers, personal digital assistants, pagers, cellular telephones, and the like. For the sake of example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be differently configured and that each of the listed components may represent several different components. For example, the CPU 222 may represent a multi-processor or a distributed processing system; the memory unit 224 may include different levels of cache memory, main memory, hard disks, and remote storage locations; and the I/O device 226 may include monitors, keyboards, and the like.

In this example, the internal entity 202 may be connected to an intermediate network (not shown) through a wireless or wired link, as further described below. The intermediate network may be further connected to the network through one or more security device or other devices. The intermediate network may be, for example, a company wide intranet that is a complete network or a subnet of a local area network. The internal entity 202 may be identified on the intermediate network by an address or a combination of addresses, such as a media control access (MAC) address associated with the network interface and an Internet protocol (IP) address. Because the internal entity 202 may be connected to the intermediate network, certain components may, at times, be shared with other internal entities. Therefore, a wide range of flexibility is anticipated in the configuration of the internal entity 202. Furthermore, it is understood that in some implementations, a server may be provided to support multiple internal entities 202. In other implementations, a combination of one or more servers and computers may together represent a single entity.

In furtherance of the example, the intermediate network may contain confidential information that may not be accessed by the external entity 204, which may comprise a laptop computer used by a customer of the company. Therefore, the external entity 204 may not be connected to the intermediate network. Instead, it is connected to the network through a wireless or wired link, as further described below. Similar to the internal entity 202, the external entity 204 may be identified on the network by an address or a combination of addresses, such as a media control access (MAC) address and an Internet protocol (IP) address.

It is understood that the entities 202-204 may be concentrated at a single location or may be distributed, and that some entities may be incorporated into other entities. In addition, each of the entity 202, 204 may be associated with system identification information that allows access to information within the system to be controlled based upon authority levels associated with each entity's identification information.

Network connections for the internal entity 202 and the external entity 204 will now be further described and contrasted. Referring now to FIG. 3, shown therein is a multiple access system 300 for both the internal entity 202 and the external entity 204 to access a network 324 according to one embodiment of the present disclosure.

In this example, the system 300 may comprise two access routes: a visitor access route 320 and an employee access route 322, each of which will be further described below. The visitor access route 320 will provide access to the network 324, which may be the Internet, but not to an intermediate network 326, which may be a confidential company intranet. In contrast, the employee access route 322 may provide access to both the intermediate network 326 and the network 324.

The visitor access route 320 will now be further described in connections with the steps 12-18 of the method 10 as illustrated in FIG. 1. In one embodiment, the visitor access route 320 may comprise the external entity 204, a first access point 302, a first router 304, a proxy server 306, a filtering device 308, and the network 324, which may be the Internet. It will be understood that a plurality of each of the first access point 302, the first router 304, the proxy server 306, and the web filtering device 308 are also contemplated by the present disclosure. Further, it will be understood that wireless networks, access points, routers, proxy servers, and filtering devices are known in the art, and will not be described in details herein.

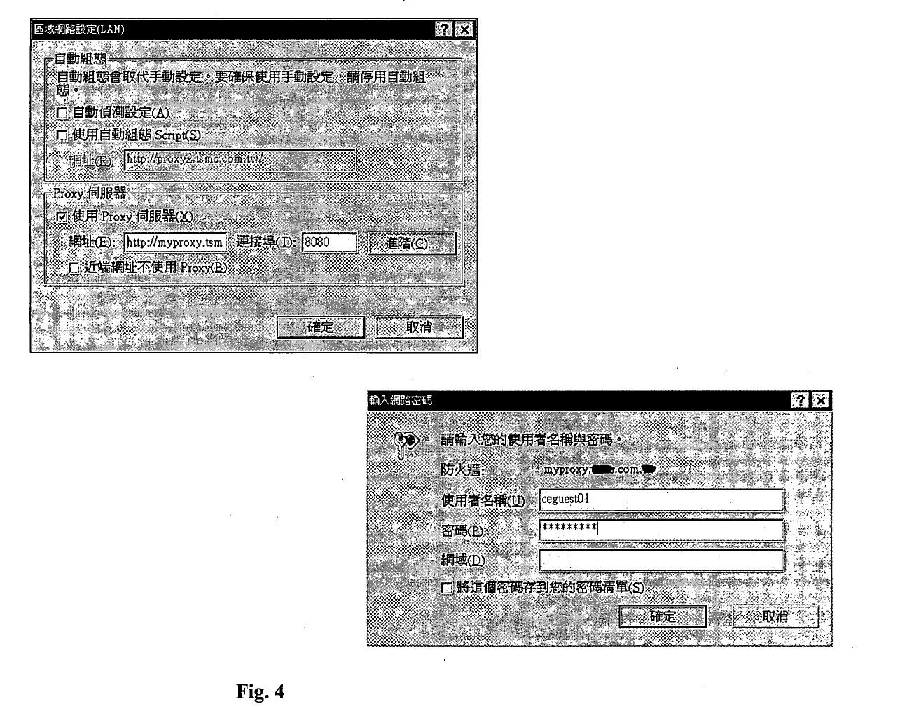

In furtherance of the example, the external entity 204 may be a visitor's laptop computer, which may be equipped with a wireless access card or other devices that are capable of communicating with the access point 302, which is provided by the step 12 of the method 10 and through a wireless network. Exemplary login screens for the external entity 204 are shown in FIG. 4. In accordance with the step 14 of the method 10, the first access point 302 may be a communication hub that eventually connects the external entity 204 to the network 324.

In this example, according to the step 16 of the method 10, the router 304 may route the connection from the access point 302 to the proxy server 306. Generally, routers act like interface between networks, such as the central switching offices of the Internet. There exist many types of routers—from a small router that connects a simple corporate LAN to the Internet, to a large router that connects the largest backbone service providers. Routers are also highly intelligent, and support many types of networks, such as Local Area Networks (LANs), Metropolitan Area Networks (MANs), and Wide Area Networks (WANs) such as X.25, Frame Relay and ATM. The router 304 may operate at layer 3 of the open systems interconnection (OSI) model, using the physical link and network layers to provide addressing and switching. Alternatively, it may operate at layer 4, the transport layer, in order to ensure end-to-end reliability of data transfer. Since the router 304 may direct traffic based on a high level of intelligence inside itself, its routing considerations might include destinations address, packet priority level, least-cost route, minimum route delay, minimum route distance, route congestion level, and community of interest. The router 304 may utilize a traditional router topology—each of its ports may define a physical subnet, and each subnet is a broadcast domain. Within that domain, all connected devices share the broadcasted traffic. However, devices outside of that domain cannot identify or respond to that traffic. Also, the router 304 may have the ability to define subnets on a logical basis, based on logical address (e.g. MAC or IP address) information contained within the packet header. In addition to a standalone router, the router 304 may also be server-based. In that case, it may be in the form of a high-performance PC with routing software. As software may perform less effectively and efficiently than firmware, such choice may be suitable for implementing the visitor access route 320, which may not require high-volume connections.

In furtherance of this example, according to the step 18 of the method 10, the proxy server 306 may provide the external entity 204 with an access to the network 324, which may be the Internet. The proxy server 306 may be a software program that resides on a PC and conducts address translation-allocating IP addresses as the need arises. Acting as behind-the-scenes directors, the proxy server 306 may also help distribute processing load, provide an added layer of security, and cache some of the material from popular web sites to save access time and cost. Further, the proxy server 306 may even establish an on-demand connection—if no traffic exists over the connection for a period of time, the proxy server 306 may turn off the connection, and re-establish the connection immediately when a visitor tries to access the network 324.

It is also contemplated that the filtering device 308 may be added for various purposes, such as content filtering, web virus scanning and proxy caching.

For illustration purposes only, among the many possible configurations, exemplary configurations for the various components of the visitor access route 320 are as follows:
Exemplary configuration for the access point 302, which may be a Cisco wireless access point:
   Service Set ID (SSID): guest
   Allow “Broadcast” SSID to Associate?: yes
   Radio Data Encryption (WEP): no
Exemplary configuration for the access point 302, which may be a Cisco router:
   # show run int vlan 110
   interface Vlan110
   description WLAN for Visitors
   ip address 10.40.110.2 255.255.255.0
   ip access-group 104 in
   no ip redirects
   ip ospf cost 10
   standby 110 priority 130 preempt
   standby 110 ip 10.40.110.1
   end
   #show run access-list 104
   access-list 104 permit tcp any established
   access-list 104 permit tcp any host 10.44.152.251 eq 8080 access-list 104 permit tcp any host 10.44.152.251 eq 443 access-list 104 permit udp any host 10.44.152.251 eq domain access-list 104 permit udp any host 10.44.152.251 eq bootps access-list 104 permit udp any host 10.44.152.251 eq netbios-ns
   access-list 104 deny ip any
Exemplary configuration for the proxy server 306:
   a. Deny company intranet web access, includes:
   *.company.com
   *.company.com.tw
   10.0.0.0
   .....
   b. Allow all Internet web access.
   c. Protocol allow: http, https, Gopher, FTP download only.
   d. Configure Web browser during firewall client setup
      DNS name: myproxy
      port 8080
   e. Specify upstream server or array configuration: port 8080, SSL port 8443
Exemplary configuration for the filtering device 308:
   Allow MYPROXY IP can access Cacheflow as its Web relay.

The employee access route 322 will now be described in connections with the steps 20-26 of the method 10. In one embodiment, the employee access route 322 may comprise the internal entity 202, a second access point 310, a second router 312, an intermediate network 326, which may be a company intranet, a security device 314, which may be a fire wall, and the network 324, which may be the Internet. It will be understood that a plurality of each of the second access point 310, the second router 312, the intermediate network 326, and the security device 314 are also contemplated by the present disclosure.

In furtherance of the example, according to the step 20 of the method 10, the second access point 304 may be provided for the internal entity 202 and used as a communication hub to connect the internal entity 202 to the intermediate network 326. Similar to the external entity 204, the internal entity 202 may be equipped with a wireless access card or other devices that are capable of connecting the internal entity 202 to the second access point 304 through a wireless network. According to the step 22 of the method 10, the second access point 310 may be connected to the router 312, which in turn may be connected to the intermediate network 326 pursuant to the step 24 of the method 10. The security device 314 may be used to protect the intermediate network 326 from unwanted intrusion from the public network 324.

In this example, the security device 314, which may be a firewall, may be provided by a proxy server or other devices. The security device 314 may allow the company to provide access to the public network 324 to selected users. Also, data encryption may be provided for the employee access route 322. It will be understood fire walls and data encryption are known in the art, and will not be further described here.

It is contemplated that the system 300 may comprise any suitable configurations. In one example, the internal entity 202 may be connected to the intermediate network 326 by wired lines. In a second example, the external entity 204 may be wired to the network 324. In a third example, both the internal entity 202 and the external entity 204 may be wired to the intermediate network 326, and the network 324, respectively. It will be understood that wired connections are known in the art and will not be further described herein. In a fourth example, the internal entity 202 and the external entity 204 may each be connected to a server, which includes a database that stores user ids, and labels them according to whether they are associated with an internal entity or an external entity. As a result, a connection stamped with a user id associated with the external entity 204 will be routed directly to the network 324 (with optional filtering mechanisms, such as the filtering device 308 and other devices). In contrast, a connection stamped with a user id associated with the internal entity 202 will be routed to the intermediate network 326. In a fifth example, a router may comprise both the routers 312 and 304. In a sixth example, access points 301 and 302 may belong to the same access point device.

Although only a few exemplary embodiments of this invention have been described in detail above, those skilled in the art will readily appreciate that many modifications are possible in the exemplary embodiments without materially departing from the novel teachings and advantages of this invention. Also, features illustrated and discussed above with respect to some embodiments can be combined with features illustrated and discussed above with respect to other embodiments. Accordingly, all such modifications are intended to be included within the scope of this invention.

1. A method for providing network access, the method comprising:
providing a first access point for a first computing device;
accessing a first router through the first access point;
connecting the first computing device to a first network;
providing a second access point for a second computing device;
accessing a second router through the second access point; and
connecting the second computing device to a second network.

2. The method of claim 1 wherein the second network is a company intranet.

3. The method of claim 1 wherein the first network is the Internet.

4. The method of claim 1 further comprising routing to a proxy server through the first router.

5. The method of claim 1 furthering comprising providing web access filtering for the first computing device.

6. The method of claim 1 further comprising denying the first router any access to the second network.

7. The method of claim 1 further comprising providing a firewall to restrict access to the second network.

8. The method of claim 1 furthering comprising providing data encryption for the second computing device.

9. The method of claim 1 wherein the first computing device is a laptop computer.

10. The method of claim 1 wherein the first computing device is a cellular telephone.

11. The method of claim 1 wherein the first access point and the second access point belong to separate devices.

12. The method of claim 1 wherein the first router and the second router belong to separate devices.

13. A computer readable medium comprising a plurality of instructions for execution by at least one computer processor, wherein the instructions are for:
providing a first access point for a first computing device;
accessing a first router through the first access point;
connecting the first computing device to a first network;
providing a second access point for a second computing device;
accessing a second router through the second access point; and
connecting the second computing device to a second network.

14. The computer readable medium of claim 13 wherein the first network is a company intranet.

15. The computer readable medium of claim 13 wherein the second network is a the Intranet.

16. The computer readable medium of claim 13 further comprising routing to a proxy server through the first router.

17. The computer readable medium of claim 13 furthering comprising providing web access filtering for the first computing device.

18. The computer readable medium of claim 13 further comprising denying the first router any access to the second network.

19. A system for providing network access, comprising:
a first access point for interacting with a first computing device;
a first router for serving the first access point and providing access to the Internet;
a second access point for interacting with a second computing device;
a second router for serving the second access point and providing access to a company intranet, wherein the first computing device is denied access to the company intranet.

20. The system of claim 19 wherein the first computing device is a laptop computer.
